(19) United States
(12) Patent Application Publication
(10) Pub. No.: US 2022/0200038 A1
(43) Pub. Date: Jun. 23, 2022

(54) UNIT CELL, AND METHOD AND APPARATUS FOR MANUFACTURING SAME

(71) Applicant: LG ENERGY SOLUTION, LTD., Seoul (KR)

(72) Inventors: Sang Ho BAE, Daejeon (KR); Su Taek JUNG, Daejeon (KR); Soon Kwan KWON, Daejeon (KR); Seong Won CHOI, Daejeon (KR); Yong Jun LEE, Daejeon (KR); Sang Woo LEE, Daejeon (KR); Won Pill HWANG, Daejeon (KR); Tae Jong KIM, Daejeon (KR)

(73) Assignee: LG ENERGY SOLUTION, LTD., Seoul (KR)

(21) Appl. No.: 17/603,136

(22) PCT Filed: Nov. 23, 2020
(86) PCT No.: PCT/KR2020/016609

§ 371 Date: Oct. 12, 2021

(30) Foreign Application Priority Data
Dec. 10, 2019 (KR) 10-2019-0164069
Nov. 13, 2020 (KR) 10-2020-0151975

(51) Int. Cl. H01M 10/04

(52) U.S. Cl. CPC H01M 10/0468

(57) ABSTRACT

Discussed is method for manufacturing a unit cell in which a certain number of separators and electrodes are alternately stacked, the method including: an adhesive applying operation of continuously providing a lower separator at a relatively lower position and an upper separator at a relatively upper position and applying an adhesive to a surface of at least one separator of the lower separator or the upper separator; an electrode inputting operation of inputting an electrode onto the lower separator; and a stacking operation of positioning and stacking the electrode between the lower separator and the upper separator. The adhesive applied on the at least one separator allows the electrode to be bonded to the at least one separator or allows the other separator to be bonded to the at least one separator, thereby preventing the electrode from moving relative to at least one of the upper and lower separators.

### CROSS-REFERENCE TO RELATED APPLICATION

The present application claims the benefit of the priority of Korean Patent Application No. 10-2019-0164069, filed on Dec. 10, 2019 and Korean Patent Application No. 10-2020-0151975, filed on Nov. 13, 2020, which are hereby incorporated by reference in their entirety.

### TECHNICAL FIELD

The present invention relates to a unit cell and a method and apparatus for manufacturing the same and, more specifically, to: a unit cell in which electrodes (a negative electrode, a positive electrode) are bonded to a separator using an adhesive unlike a lamination method using heat and pressure according to the related art, thereby preventing the electrodes and the separator from moving; and a method and apparatus for manufacturing the same.

### BACKGROUND ART

Secondary batteries are rechargeable unlike primarily batteries, and also, the possibility of compact size and high capacity is high. Thus, recently, many studies on secondary batteries are being carried out. As technology development and demands for mobile devices increase, the demands for secondary batteries as energy sources are rapidly increasing.

Such a secondary battery is configured such that an electrode assembly is accommodated in a battery case (a pouch, a can, and the like). The electrode assembly mounted inside the battery case is repeatedly chargeable and dischargeable because of its structure in which a positive electrode/a separator/a negative electrode are stacked. The electrode assembly is manufactured in various methods, but a method is generally used, in which a unit cell 4 is manufactured in advance and then a plurality of unit cells 4 are stacked to manufacture the electrode assembly.

That is, referring to FIG. 1 schematically illustrating a state in which a unit cell is manufactured through a method according to the related art, a method for manufacturing a unit cell 4 according to the related art is configured such that a positive electrode 1, a separator 3 at a relatively upper position, a negative electrode 2, and a separator 3 at a relatively lower position, which have been stacked in this order from the upper side and wound in a roll shape, are continuously unwound and supplied.

Here, the separators 3 are continuously supplied without disconnection, the negative electrode 2 is supplied between the separators 3, and the positive electrode 1 is supplied above the upper separator 3. These electrodes, which have been cut into a predetermined size, are input at constant intervals. Here, input timing is controlled so that the negative electrode 2 and the positive electrode 1 are stacked vertically corresponding to each other. Thus, the separators 3 are continuously connected, but the negative electrode 2 and the positive electrode 1 continuously pass through a laminating device while spaced a certain distance from a neighboring negative electrode 2 and a neighboring positive electrode 1.

While passing through the laminating device, spaces between the positive electrode 1, the separator 3, and the negative electrode 2 are heated and pressed by nip rollers 5. That is, the laminating (bonding) is made by heating and pressing, and then, the separators 3 are cut, whereby an individual unit cell 4 is manufactured.

However, in the method according to the related art described above, the electrodes (the positive and negative electrodes) may be moved away from original right positions or damaged while being heated and pressed. Also, when the heating is not uniform, adhesion force between the electrodes 1 and 2 and the separator 3 may become irregular.

### DISCLOSURE OF THE INVENTION

### Technical Problem

Thus, main objects of the present invention are to provide: a method and apparatus for manufacturing a unit cell, which may solve the problem occurring in a laminating process of the related art; and a unit cell manufactured by the above method and apparatus.

### Technical Solution

To achieve the above-described objects, the present invention provides: a method and apparatus for manufacturing a unit cell, in which an electrode is bonded (laminated) to a separator by an adhesive; and a unit cell which may be manufactured by the above method and apparatus.

A method for manufacturing a unit cell, in which a certain number of separators and electrodes are alternately stacked, according to the present invention comprises: an adhesive applying step of continuously providing a lower separator located at a relatively lower position and an upper separator located at a relatively upper position and applying an adhesive to a surface of at least one of the lower separator or the upper separator; an electrode inputting step of inputting an electrode (one of a positive electrode and a negative electrode) onto the lower separator; and a stacking step of positioning and stacking the electrode between the lower separator and the upper separator, wherein the adhesive applied on the separator allows the electrode to be bonded to the separator or the other separator to be bonded to the separator, thereby preventing the electrode from moving.

In the adhesive applying step, the adhesive may be applied to a region except for a region in which the electrode is stacked, and the separators with the electrode therebetween are bonded to each other.

In the adhesive applying step, the adhesive may be applied to a region in which the electrode is stacked, and the electrode and one of the upper separator and the lower separator may be bonded to each other over at least a portion of contact surfaces thereof.

Also, the electrode (the positive electrode and the negative electrode) has a rectangular shape with two short sides being relatively short and two long sides being relatively longer.

Here, in the adhesive applying step, the adhesive may be applied to a region in which the short sides of the electrode is to be positioned. Alternatively, in the adhesive applying step, the adhesive may be applied to all regions in which four vertices connecting the short sides and the long sides of the electrode are to be positioned. Alternatively, in the adhesive applying step, the adhesive may be applied to all regions in which the short sides and the long sides of the electrode are to be positioned.

In addition, in the adhesive applying step, the adhesive may be further applied to a region which is parallel to the long sides of the electrode and has both ends respectively connected to the short sides.

Also, the method may further comprise a roller passing step of allowing the lower separator, the upper separator, and the electrode, which are stacked on each other, to pass through between nip rollers that face each other, thereby pressing the lower separator, the upper separator, and the electrode.

In addition, in the adhesive applying step, the adhesive may be applied in the form of mist in a manner in which the adhesive is sprayed in the form of small particles together with compressed air, or may be applied in the form of droplets in a manner in which the adhesive is ejected by a change in volume of a pressure chamber that stores the adhesive.

After the adhesive applying step, an individual unit cell, in which a certain number of the upper separators, the lower separators, and the electrodes are alternately stacked, may be provided through a cutting process.

The present invention provides a method for manufacturing a unit cell according to another embodiment. A method for manufacturing a unit cell according to the embodiment comprises: a step of continuously conveying and supplying, in a longitudinal direction, a lower separator which is located at a relatively lower position; a step of applying an adhesive to a portion of a top surface of the lower separator; a step of mounting, on the lower separator, one of a negative electrode or a positive electrode which is cut into a predetermined size and located on one side of the lower separator; a step of continuously conveying and supplying an upper separator which is located at a relatively upper position; and a step of applying an adhesive to a portion of one surface of the upper separator, wherein the upper separator is supplied from the upper side in a direction perpendicular to a traveling direction of the lower separator, and is horizontally conveyed while the adhesive is applied so that the adhesive is applied vertically from the upper side, and wherein the upper separator is stacked on the electrode such that one surface of the upper separator on which the adhesive has been applied is placed on a top surface of the electrode.

The upper separator is conveyed along a nip roller pressing the lower separator and the electrode and a guide roller disposed above the nip roller, and both surfaces of the upper separator are reversed. When the one surface of the upper separator is laid horizontally while conveyed along the guide roller, the adhesive is applied onto the one surface, and the upper separator is input between the nip roller and the electrode such that the one surface on which the adhesive has been applied covers the top surface of the electrode.

The method further comprises a step of further applying an adhesive to a portion of the top surface of the upper separator after the upper separator is stacked on the electrode. After the step of further applying the adhesive to the portion of the top surface of the upper separator, the method comprises a step of further mounting an electrode onto the top surface of the upper separator on which the adhesive has been applied, wherein the electrode mounted on the top surface of the upper separator has a different polarity from the electrode stacked between the upper separator and the lower separator.

The method may comprise a step of allowing the lower separator, the electrode, the upper separator, and the electrode, which are stacked in this order from the lower side to the upper side, to pass through between a pair of additional nip rollers, thereby pressing the lower separator, the electrode, the upper separator, and the electrode.

An apparatus for manufacturing a unit cell according to the present invention comprises: a lower reel from which a lower separator located at a relatively lower position is unwound; a first nozzle configured to apply an adhesive to a top surface of the unwound lower separator; an upper reel from which an upper separator located at a relatively upper position is unwound; a second nozzle configured to apply an adhesive to one surface of the unwound upper separator; a guide roller configured to change a conveyance direction of the upper separator so that the upper separator unwound from the upper reel passes horizontally under the second nozzle; and a nip roller configured to input the upper separator onto an electrode such that, after passing through the guide roller, the one surface of the upper separator on which the adhesive has been applied faces downward and is bonded to a top surface of the electrode mounted on the top surface of the lower separator.

The apparatus may comprise a first gripper configured to mount the electrode on the top surface of the lower separator on which the adhesive has been applied, and a first vision which is disposed above the electrode and captures an image of a position, in which the electrode is mounted by the first gripper, prior to bonding the electrode to the lower separator.

The nip roller is disposed on each of both sides of a first stack, which is formed by stacking the lower separator, the electrode, the upper separator in this order, and presses the first stack while rotating.

The nip roller and the guide roller are spaced a certain distance from each other, and the upper separator remains horizontal while the upper separator is conveyed between the nip roller and the guide roller.

The upper separator is stacked such that the surface of the upper separator, on which the adhesive has been applied, is placed as a bottom surface by the nip roller so as to come into contact with the electrode, and the apparatus further comprises a third nozzle configured to apply an adhesive to a top surface of the upper separator after the upper separator is stacked on the electrode.

The apparatus comprises a second gripper configured to mount an electrode, which has a different polarity from the electrode stacked below the upper separator, on the top surface of the upper separator on which the adhesive has been applied.

The apparatus may comprise an auxiliary nip roller which is disposed on each of both sides of a second stack, which is formed by mounting the lower separator, the electrode, the upper separator, and the electrode in this order from the lower side below, and presses the second stack while rotating.

The apparatus may comprise a second vision configured to capture an image of a position, in which the electrode is mounted by the second gripper, prior to mounting the electrode onto the upper separator.

In addition, in the embodiment, each of the first nozzle, the second nozzle, and the third nozzle comprises a plurality of nipples having ends through which the adhesives are applied, and the nipples of each of the first nozzle, the second nozzle, and the third nozzle are spaced apart from each other so that nipples disposed outside apply the adhesives in the vicinity of an edge of the electrode, and a nipple disposed between the nipples applies the adhesives to the vicinity of the center of the electrode.

Spray speeds and spray amounts of the adhesives, which are sprayed from the nipples of each of the first nozzle, the second nozzle, and the third nozzle, may be individually controlled.

Also, the present invention provides a unit cell which is manufactured through the manufacturing method and apparatus described above.

A unit cell, in which a certain number of separators and electrodes are alternately stacked, according to the present invention is manufactured by stacking a lower separator, one of a negative electrode or a positive electrode, an upper separator, and the other of the negative electrode or the positive electrode in this order from the lower side to the upper side, wherein an adhesive is applied to contact surfaces on which the electrode and the separator come into contact with each other, and the electrode and the separator are bonded.

The adhesive is applied in such a manner in which a plurality of rows are formed along a specific direction in a plurality of points spaced apart from each other.

A gap between points in which the adhesive is applied in a specific row is less than a gap between points in which the adhesive is applied in another row.

An area of the points in which the adhesive is applied in the specific row is greater than an area of the points in which the adhesive is applied in another row.

### Advantageous Effects

In the method for manufacturing the electrode assembly according to the present invention having the above-described technical features, because the heat and pressure may not or need not be applied or may be applied much weaker than the related art when the electrode and the separator are laminated, the distortion between the separator and the electrode may be prevented, and the deformation of the electrode and the separator, the damage thereto, and the like may be prevented.

In the present invention, according to the application position of the adhesive, the separators are bonded to each other, or the separator is bonded to the electrode, whereby the electrode may be fixed. That is, according to the properties of the electrode such as size and thickness, the adhesive is applied to the region to which the electrode is mounted, and thus the separator may directly fix and prevent the electrode from moving, or the separators stacked on both sides of the electrode are bonded to each other, whereby the electrode may be prevented from moving.

In addition, since the adhesive may be partially applied to only very small regions such as the corners of the electrode in the manufacturing method of the present invention, when this method is additionally applied to the lamination process of the related art in which the heat and pressure are applied, the position of the electrode may be temporarily fixed before the lamination process is conducted.

In the present invention, the adhesive is ejected in the form of small particles and thus may be dispersed and impregnated between coating layers on the surface of the separator.

Also, since the electrodes (the positive electrode, the negative electrode) may be input through the visions and the grippers, the electrode may be input and mounted to more accurate position compared to the method in which a cutting speed of a cutter is controlled.

In addition, since the application amount may be controlled in a specific region of the unit cell according to the present invention, the optimal bonding state may be provided according to the usage of the unit cell and the characteristics of the separator and the electrode.

### BRIEF DESCRIPTION OF THE DRAWINGS

FIG. 1 is a view schematically illustrating a state in which a unit cell is being manufactured through a method according to the related art.

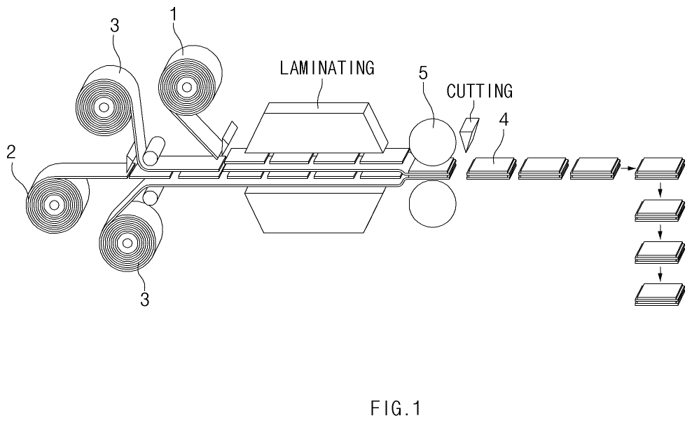

FIG. 2 is a view schematically illustrating a state in which manufacturing is being carried out through a manufacturing method according to a first embodiment of the present invention.

FIG. 3 is a view schematically illustrating a state in which an adhesive is sprayed in the form of mist.

FIG. 4 is a view schematically illustrating a state in which an adhesive is sprayed in the form of droplets.

FIG. 5 is a view illustrating a state in which an adhesive is impregnated into a surface of a coating layer of a separator.

FIG. 6 is a view illustrating positions (a) to (f) in which an adhesive may be applied with respect to an electrode.

FIG. 7 is a view schematically illustrating a state in which a unit cell is being manufactured through a manufacturing method according to a second embodiment of the present invention by a manufacturing apparatus according to a third embodiment.

FIG. 8 is a view schematically illustrating a state when the state of FIG. 7 is viewed from the side.

FIG. 9 is a view schematically illustrating a state when the state of the FIG. 7 is viewed from the top to the bottom.

FIG. 10 is a view showing points ‘a’ to which an adhesive is applied by a first nozzle before the negative electrode is stacked on the lower separator.

FIG. 11 is a view (in a state in which an upper separator is stacked on a negative electrode) showing points to which an adhesive is applied by a first nozzle and a second nozzle after an upper separator is stacked on a negative electrode.

FIG. 12 is a view showing points to which an adhesive is applied by a third nozzle before a positive electrode is stacked on a top surface of an upper separator stacked on a negative electrode.

FIG. 13 is a view showing points in which adhesives are applied in a unit cell according to the present invention.

### MODE FOR CARRYING OUT THE INVENTION

Hereinafter, embodiments of the present invention will be described in detail with reference to the accompanying drawings so that those skilled in the art can easily carry out the present invention. However, the present invention may be modified in various different forms, and is not limited to the exemplary embodiments described herein.

A part irrelevant to the description will be omitted to clearly describe the present invention, and the same or similar elements will be designated by the same reference numerals throughout the specification.

Also, terms or words used in this specification and claims should not be restrictively interpreted as ordinary meanings or dictionary-based meanings, but should be interpreted as meanings and concepts conforming to the scope of the present invention on the basis of the principle that an inventor can properly define the concept of a term to describe and explain his or her invention in the best ways.

The present invention relates to a method for manufacturing a unit cell in which a certain number of separators 30 and electrodes (a positive electrode 10 and a negative electrode 20) are alternately stacked. Hereinafter, the present invention will be described in more detail with reference to the accompanying drawings.

### First Embodiment

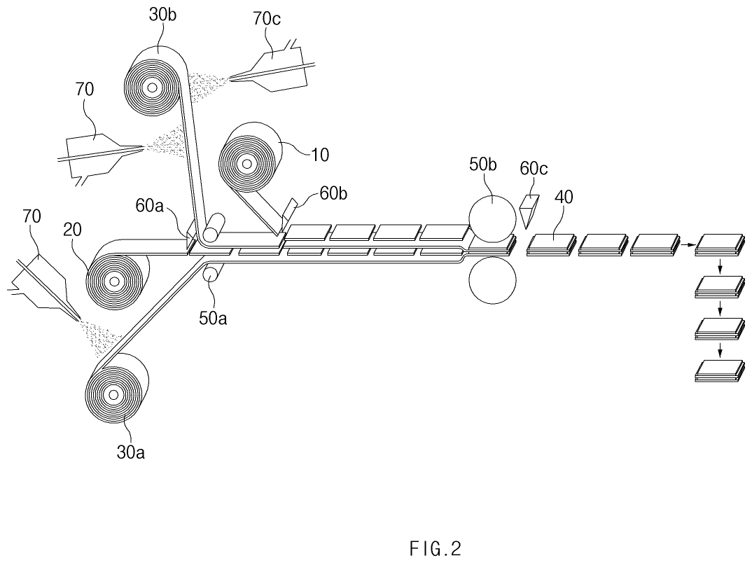

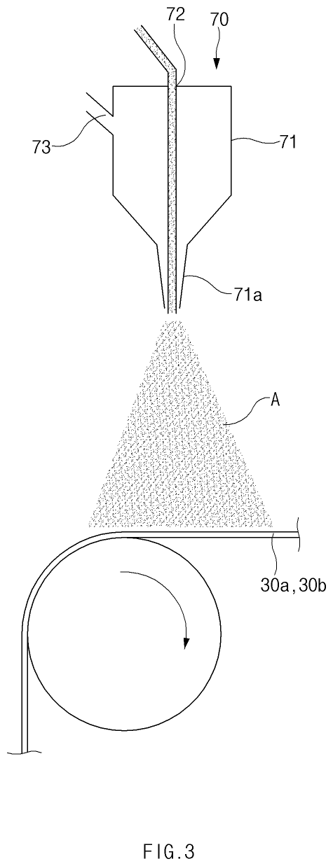

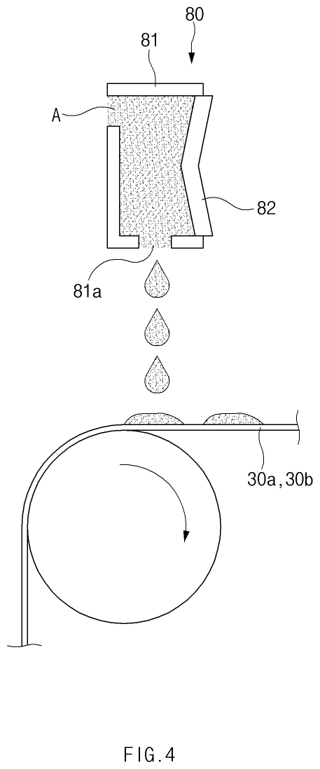

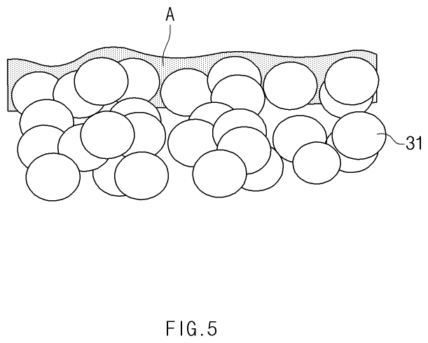

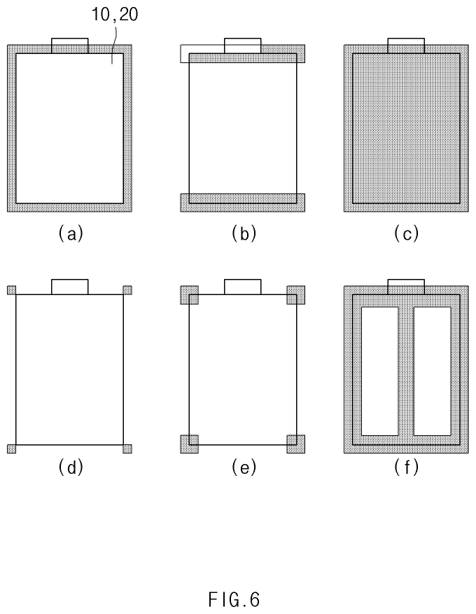

FIG. 2 is a view schematically illustrating a state in which manufacturing is being carried out through a manufacturing method according to a first embodiment of the present invention, FIG. 3 is a view schematically illustrating a state in which an adhesive is sprayed in the form of mist, and FIG. 4 is a view schematically illustrating a state in which an adhesive is sprayed in the form of droplets. Also, FIG. 5 is a view illustrating a state in which an adhesive is impregnated into a surface of a coating layer of a separator, and FIG. 6 is a view illustrating positions (a) to (f) in which an adhesive may be applied with respect to an electrode.

A method for manufacturing a unit cell provided in the embodiment comprises an adhesive applying step, an electrode inputting step, and the stacking step. Also, the unit cell has a structure in which a certain number of a negative electrode 20, a separator 30, and a positive electrode 10 are stacked repeatedly.

First, in the electrode inputting step, separators (that is, a lower separator 30a and an upper separator 30b) wound in a roll shape are individually unwound from two places and continuously provided. Also, electrodes (a positive electrode or a negative electrode), which have been cut into an appropriate size by cutter 60a and 60b, are input and stacked between the separators 30a and 30b or on a top surface of the upper separator 30b placed at an upper position.

That is, according to input sequences and input positions of the electrodes, the unit cell provided in the embodiment may have a structure in which the positive electrode 10/the upper separator 30b/the negative electrode 20/the lower separator 30a are stacked in this order from the upper side or a structure having the order of the negative electrode 20/the upper separator 30b/the positive electrode 10/the lower separator 30a.

Here, in the present invention, the separators 30a and 30b are provided respectively from at least two places, and thus two or more sheets of separators are continuously input. Particular, in the present invention, the adhesive applying step of applying an adhesive A on surfaces of the separators 30a and 30b is performed, prior to inputting the positive electrode 10 and the negative electrode 20, that is, before the electrode inputting step is completed.

In the adhesive applying step, the adhesive A applied to the separators 30a and 30b may be applied to positions for directly bonding the electrodes 10 and 20 to the separators 30a and 30b or positions for bonding the separators 30a and 30b to each other. Here, in both cases, the electrodes 10 and 20 may be prevented from moving.

That is, making an explanation with respect to the negative electrode 20 stacked between the separators 30a and 30b, the negative electrode 20 is located between the lower separator 30a at the lower position and the upper separator 30b at the upper position.

The negative electrode 20 may be prevented from moving, when bonded to at least one of the lower separator 30a at the lower position or the upper separator 30b at the upper position. In addition, when the lower separator 30a at the lower position and the upper separator 30b at the upper position are bonded to each other with the negative electrode 20 therebetween along edges of the negative electrode 20, a space, in which the negative electrode 20 is movable, is restricted, and thus, the negative electrode 20 may be prevented from moving.

However, since there is the upper separator 30b only below the positive electrode 10 placed as the uppermost layer, the adhesive A has to be applied to contact portions between the upper separator 30b and the positive electrode 10 so as to restrict the movement the positive electrode 10.

That is, in the adhesive applying step, the adhesive A is applied to a region except for a region in which the negative electrode 20 is stacked, and thus the separators 30a and 30b with the negative electrode 20 therebetween may be bonded to each other in the stacking step, or the adhesive A is applied to a region of any one of the two separators 30a and 30b on which the negative electrode 20 is stacked, and thus the separators 30a and 30b and the negative electrode 20 may be bonded to each other in at least a portion of the contact surfaces. On the other hand, with respect to a place in which the positive electrode 10 is positioned, the adhesive A is applied to a top surface of the upper separator 30b corresponding to a region in which the positive electrode 10 is positioned.

Referring to FIG. 6 illustrating positions (a) to (f) in which the adhesive A may be applied with respect to the electrode (a region indicated by dots in FIG. 6 represents a position in which the adhesive is applied), each of the positive electrode 10 and the negative electrode 20 of the present invention has a rectangular shape with two short sides being relatively short and two long sides being relatively longer, and are stacked such that the long sides are parallel to the width direction of the separators 30a and 30b.

Also, as illustrated in (a), the adhesive A may be applied to only a certain region of the separators 30a and 30b along edges of the electrodes 10 and 20, but the region is not in contact with the electrodes 10 and 20. Here, the adhesive A may be selectively applied or not applied to an electrode tab that protrudes from the electrodes 10 and 20.

Also, as in (b), the adhesive A may be applied only to regions in which both the short sides of the electrodes 10 and 20 are placed so that the electrodes 10 and 20 and the separators 30a and 30b are bonded to each other only in both the short sides of the electrodes 10 and 20. In addition, as in (c), the adhesive A may be applied to regions, in which the separators 30a and 30b come into contact with each other, as well as to the electrodes 10 and 20 so that all of the contact surfaces of the separators 30a and 30b and the electrodes 10 and 20 are bonded to each other.

Furthermore, as in (d) and (e), the adhesive A may be applied only to regions in which four vertices of the electrodes 10 and 20 are to be positioned. Also, as in (f), additional adhesive application may be made in a region between both the short sides or between both the long sides of the electrodes 10 and 20 as well as regions in which the short sides and the long sides are to be positioned.

In such a state in which the adhesive A is applied to the separators 30a and 30b, the stacking step is made by stacking the separators 30a and 30b and the electrodes 10 and 20. That is, in the stacking step, the two sheets of separators 30a and 30b and the electrodes 10 and 20 are alternately positioned and stacked.

In addition, after the stacking step, a roller passing step may be further selectively performed, in which, so that the separator 30 on which the adhesive A has been applied is further efficiently bonded to the electrode or the separator provided together, the stacked separators and electrodes are pressed by facing nip rollers 50a and 50b while passing therethrough.

The nip rollers 50a and 50b press the electrodes 10 and 20 and the separators 30a and 30b with pressure much less than that of a laminating method according to the related art. Also, the pressing may be made at a lower temperature without heating. Through the method described above, damage to the electrodes 10 and 20 and the separators 30a and 30b or short-circuits thereof may be prevented.

In addition, after the adhesive applying step, the separators 30a and 30b and the electrodes 10 and 20 are cut by a cutter 60c into an individual unit cell 40 in which a certain number of the separators 30a and 30b and the electrodes 10 and 20 are alternately stacked. The cutter 60c may have a size greater than that of each of cutters 60a and 60b that cut the negative electrode 20 and the positive electrode 10.

Here, in the present invention, two types of methods are provided as a method for applying an adhesive.

### Spray Jet

Referring to FIG. 3, provided is a spray jet method in which adhesive particles and compressed air are sprayed together.

In a spray device 70 according to this method, a pipe 72 receiving an adhesive A is inserted into a housing 71 having a space provided therein. When the adhesive A passes through the pipe 72 and is ejected through a nozzle 71a of the housing 71, compressed air is injected through a line 73 connected to the housing 71, and the adhesive A is discharged with the compressed air through the nozzle 71a.

When the adhesive A is discharged with the compressed air, particles are split into mist by the compressed air and then applied, in the split state, to surfaces of the separators 30a and 30b.

### Inkjet Spray

Referring to FIG. 4, in this method, an adhesive A is sprayed in the form of fine droplets by a change in pressure inside a pressure chamber.

That is, a spray device 80 of the embodiment has a housing 81 which has a space provided therein, and a wall 82 on one side thereof is moved to cause a change in volume inside the pressure chamber. When the adhesive A is filled into the pressure chamber, the adhesive A is not discharged through a discharge port 81a due to viscosity thereof in a state in which the adhesive A is filled. However, when the wall 82 moves in a direction for reducing the volume of the pressure chamber, the pressure inside the pressure chamber is increased, and the adhesive A is discharged to the outside through the discharge port 81a and then applied onto the separator 30. Then, when the wall 82 is restored to the original state thereof, the discharging of the adhesive A is stopped. That, the principal that the adhesive A is applied in the embodiment is similar to the principal that ink is ejected in an inkjet printer.

The adhesive A applied through the spray jet method or the inkjet spray method described above may be applied in the form of small particles at predetermined positions and with predetermined amounts. Thus, as illustrated in an enlarged view of FIG. 5 showing a state in which an adhesive is impregnated into a surface of a coating layer 31 of the separator, the adhesive A is uniformly applied to the surface of the coating layer 31 of the separator and then permeates evenly an overall area on which the adhesive has been applied. Therefore, optimal adhesion force may be attained without loss of the adhesive A.

### Second Embodiment

As a second embodiment, the present invention provides a manufacturing method in which an electrode may be input more accurately, and an adhesive A may be applied more precisely in the vertical direction (that is, from the top to the bottom) so that a spray direction is not affected by gravity.

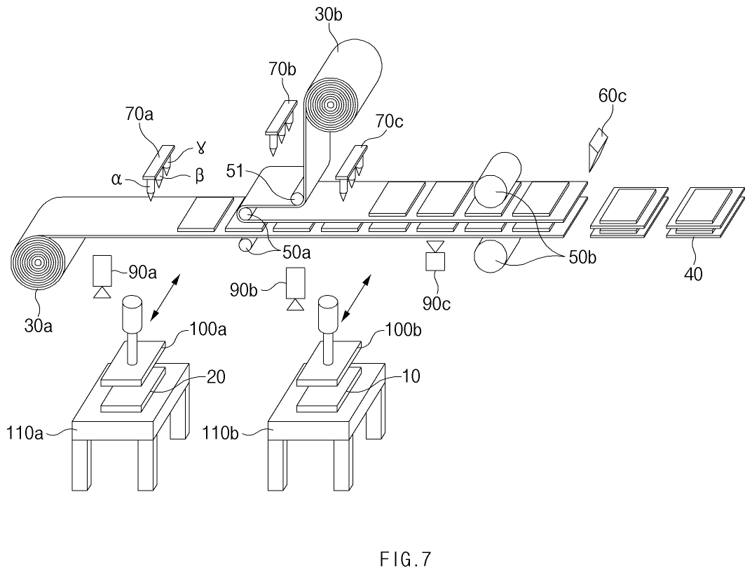

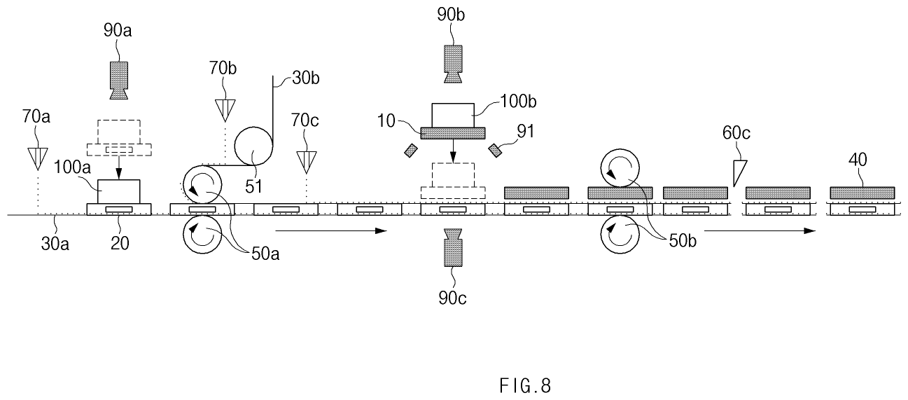

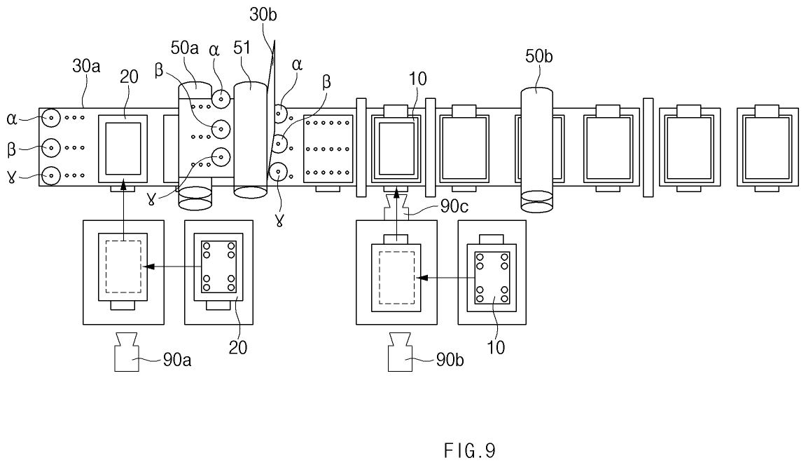

FIG. 7 is a view schematically illustrating a state in which a unit cell is being manufactured through a manufacturing method according to the second embodiment of the present invention by a manufacturing apparatus according to a third embodiment described later, FIG. 8 is a view schematically illustrating a state when the state of FIG. 7 is viewed from the side, and FIG. 9 is a view schematically illustrating a state when the state of the FIG. 7 is viewed from the top to the bottom.

Similar to the manufacturing method of the first embodiment, the manufacturing method of the embodiment also provides a method for manufacturing a unit cell 40 by stacking an electrode 10 and separators 30a and 30b. An adhesive A is applied in advance when electrodes 10 and 20 are mounted on the separators 30a and 30b, thereby preventing the electrodes 10 and 20 from moving even though not using an expensive separator.

A method for manufacturing a unit cell according to the embodiment comprises: a step of continuously conveying and supplying, in a longitudinal direction, a lower separator 30a which is located at a relatively lower position; a step of applying an adhesive A to a portion of a top surface of the lower separator 30a; a step of mounting, on the lower separator, one of a negative electrode 20 or a positive electrode 10 which is cut into a predetermined size and located on one side of the lower separator 30a; a step of continuously conveying and supplying an upper separator 30b which is located at a relatively upper position; and a step of applying an adhesive A to a portion of one surface of the upper separator 30b.

Here, the upper separator 30b is supplied from the upper side (from the upper side to the lower side in FIG. 7) in a direction perpendicular to a traveling direction (from the left side to the right side in FIG. 7) of the lower separator 30a, and is horizontally (the left and right direction in FIG. 7) conveyed while the adhesive A is applied so that the adhesive A is applied vertically from the upper side. The upper separator 30b is stacked on the electrode such that the one surface of the upper separator 30b on which the adhesive A has been applied is placed on a top surface of the electrode.

The upper separator 30b is conveyed along a nip roller 50a pressing the lower separator 30a and the negative electrode 20 and a guide roller 51 disposed above the nip roller 50a, and both surfaces thereof are reversed. That is, when the one surface of the upper separator 30b is laid horizontally while conveyed along the guide roller 51, the adhesive A is applied onto the one surface, and the upper separator 30b is input between the nip roller 50a and the negative electrode 20 such that the one surface on which the adhesive A has been applied covers the top surface of the negative electrode 20. That is, in the embodiment, the upper separator 30b is input as being turned upside down after the adhesive A is applied.

After the upper separator 30b is stacked on the negative electrode 20, there is further provided a step of further applying an adhesive to a portion of the top surface of the upper separator 30b. Also, after the step of further applying the adhesive A to the portion of the top surface of the upper separator 30b, there is provided a step of further mounting the positive electrode 10 onto the top surface of the upper separator 30b on which the adhesive A has been applied.

The electrode mounted on the top surface of the upper separator 30b is the positive electrode 10, which has a different polarity from the negative electrode 20 stacked between the upper separator 30b and the lower separator 30a. That is, when the electrode placed between the upper separator 30b and the lower separator 30a is the negative electrode 20, the electrode stacked on the upper separator 30b is the positive electrode 10, or vice versa.

There is further provided a step of allowing the lower separator 30a, the electrode, the upper separator 30b, and the electrode, which are stacked in this order from the lower side to the upper side, to pass through between a pair of additional nip rollers 50b, thereby pressing the lower separator 30a, the electrode, the upper separator 30b, and the electrode.

Also, the separators 30a and 30b between the electrodes may be cut by a cutter 60c, thereby manufacturing an individual unit cell 40.

### Third Embodiment

As a third embodiment, the present invention provides a manufacturing apparatus capable of performing the manufacturing method according to the second embodiment.

Referring to FIGS. 7 to 9, an apparatus for manufacturing a unit cell according to the embodiment comprises: a lower reel from which a lower separator 30a located at a relatively lower position is unwound; a first nozzle 70a which applies an adhesive to at least a portion of a top surface, facing upward, of the unwound lower separator 30a; an upper reel from which an upper separator 30b located at a relatively upper position is unwound; a second nozzle 70b which applies an adhesive to at least a portion of one surface, facing upward, of the unwound upper separator 30b; a guide roller 51 which changes the conveyance direction of the upper separator 30b so that the upper separator 30b unwound from the upper reel passes horizontally under the second nozzle 70b; and a nip roller 50a which inputs the upper separator 30b onto an electrode (a negative electrode 20 in the drawing) such that, after passing through the guide roller 51, the one surface of the upper separator 30b on which the adhesive has been applied by the second nozzle 70b faces downward and is bonded to a top surface of the electrode mounted on one surface of the lower separator 30a.

Here, the upper reel and the lower reel may comprise rotary devices (not shown) for rotating and unwinding the lower separator 30a and the upper separator 30b and power devices connected to the rotary devices.

The negative electrode 20 is mounted on the top surface of the lower separator 30a unwound from the lower reel, and the upper separator 30b unwound from the upper reel is stacked on the negative electrode 20. Accordingly, the lower separator 30a, the negative electrode 20, and the upper separator 30b are stacked in this order.

The first nozzle 70a, the second nozzle 70b, and a third nozzle 70c described later may spray the adhesive A through not only the spray method or inkjet method described in the first embodiment, but also various spray methods such as a dispensing method or a screen printing method.

Here, the spray method may change depending on chemical properties of the adhesive being sprayed, and the first nozzle 70a, the second nozzle 70b, and the third nozzle 70c may spray adhesives having different characteristics. With respect to the conveyance direction of the lower separator 30a (that is, with respect to FIG. 7), the first nozzle 70a is located before a position in which the negative electrode 20 is stacked, the second nozzle 70b is located between the guide roller 51 and the position in which the negative electrode 20 is stacked, and the third nozzle 70c is located after a position of the guide roller 51.

Here, in the drawing, the first nozzle 70a, the second nozzle 70b, and the third nozzle 70c are illustrated as spraying adhesives in a direction perpendicular, i.e., at 90 degrees to the surfaces of the separators 30a and 30b, but the spray angles of the first nozzle 70a, the second nozzle 70b, and the third nozzle 70c may be adjusted according to the surfaces of the separators 30a and 30b on which the adhesive is sprayed. For example, although not illustrated in the drawing, refrigerating and air conditioning devices, sensor devices, lighting devices, electric control devices, and the like may be disposed during a manufacturing process, and these devices may interfere with the nozzles 70a,70b, and 70c. Thus, within a range not negatively affecting the spray of adhesive, the spray angles of the nozzles 70a, 70b, and 70c may be controlled to various angles (for example, 30 degrees, 45 degrees, and 60 degrees, 135 degrees, 150 degrees, or the like).

Also, according to circumstances, when the sprayed adhesive has sufficient viscosity and thus does not flow down, the nozzles 70a, 70b, and 70c may be disposed such that the adhesive is sprayed upward from below the separators 30a and 30b. For example, the conveyance path of the upper separator 30b may change depending on a path on which the guide roller 51 is disposed, and here, the second nozzle 70b may be disposed below the upper separator 30b and configured such that the adhesive is sprayed from the lower side toward the upper side.

Also, as the adhesive A used in the present invention, a polyurethane-based adhesive, a polyolefin adhesive, a poly urethane reactive (PUR)-based adhesive, an acrylic adhesive, or the like may be selected, or a mixture of two or more thereof may be used. Also, thermosetting or photocurable components may be further added to shorten drying time.

Here, each of the negative electrode 20 and the positive electrode 10 provided in the embodiment is manufactured by applying slurry of an active material, a conductive material, and a binder onto an electrode collector and then drying and pressing the resultant. Also, after the electrode is manufactured in a separate processing line, the electrode is cut into a predetermined size and then provided.

That is, the negative electrode 20 may be provided in a state of being stored in a first magazine provided on one side on which the lower separator 30a is disposed, and the positive electrode 10 may be provided in a state of being stored in a second magazine which is spaced apart from the first magazine on the one side on which the lower separator 30a is disposed.

The negative electrode 20 and the positive electrode 10 provided in a state of being stored in the first magazine and the second magazine may be moved one by one to tables 110a and 110b, respectively, or may be moved directly on the lower separator 30a and the upper separator 30b by a first gripper 100a and a second gripper 100b without going through the tables 110a and 110b.

That is, the first gripper 100a and the second gripper 100b are provided in the embodiment so that the negative electrode 20 and the positive electrode 10, which have been cut into a certain size, are conveyed onto the separators 30a and 30b. For reference, each of the first gripper 100a and the second gripper 100b has the structure of tongs and is configured to move the negative electrode 20 and the positive electrode 10 while gripping the same. However, the gripper may be configured to convey the negative electrode 20 and the positive electrode 10 by vacuum-suctioning the surfaces of the electrodes, moving the same to a desired position, and then releasing the vacuum state.

Thus, the negative electrode 20 and the positive electrode 10 may be conveyed onto the lower separator 30a to which the adhesive is applied from the first nozzle 70a and the upper separator 30b to which the adhesive is applied from the third nozzle 70c, respectively.

Here, the upper separator 30b vertically conveyed downward above the lower separator 30a changes in direction through the guide roller 51. That is, the guide roller 51 changes the conveyance direction when the upper separator 30b is unwound and conveyed so that one surface of the upper separator 30b faces upward.

Also, when the second nozzle 70b sprays the adhesive on the surface, facing upward, of the upper separator 30b, the upper separator 30b is turned upside down through the nip roller 50a, and the surface, on which the adhesive is sprayed, is stacked on the negative electrode 20. Here, while the upper separator 30b passes through between the nip roller 50a and the guide roller 51, the upper separator 30b remains horizontal, and the adhesive is applied or sprayed thereon.

The nip roller 50a is also further disposed below the lower separator 30a. Thus, the pair of nip rollers 50a disposed vertically may press the lower separator 30a, the negative electrode 20, and the upper separator 30b in the stacking direction.

In addition, in the embodiment, an auxiliary nip roller 50b is further disposed, and the auxiliary nip roller 50b is also disposed vertically in a pair. The adhesive A is applied onto the upper separator 30b, and the positive electrode 10 is input. Then, the upper separator 30b and the positive electrode 10 pass through therebetween.

After passing through the auxiliary nip rollers 50b, a region between the neighboring positive electrodes 10 is cut by the cutter 60c, whereby an individual unit cell 40 may be manufactured.

Here, the manufacturing apparatus provided in the embodiment may be further provided with a first vision 90a, a second vision 90b, and a third vision 90c.

The first vision 90a is disposed above the negative electrode 20 and captures an image of a position, in which the negative electrode 20 is mounted by the first gripper 100a, before the negative electrode 20 reaches the lower separator 30a, and the second vision 90b is disposed above the positive electrode 10 and captures an image of a position, in which the positive electrode 10 is mounted by the second gripper 100b, before the positive electrode 10 reaches the upper separator 30b. Also, the third vision 90c is further disposed at a selected position on a path through which the separators 30a and 30b are conveyed, and captures images of the stack states and conveyance states of the negative electrode 20, the positive electrode 10, and the separators 30a and 30b.

The first vision 90a, the second vision 90b, and the third vision 90c capture images of the conveyance states of the grippers 100a and 100b and the electrodes 10 and 20, and are configured to transmit the captured image signals to computing device (not shown) that controls operation of each device. On the basis of the received image signals, the computing device controls the operation of the grippers 100a and 100b, the nozzles 70a, 70b, and 70c, and the upper reel and the lower reel. The first vision 90a, the second vision 90b, and the third vision 90c may comprise image capturing elements such as a charge coupled device (CCD) or a complementary metal-oxide semiconductor (CMOS), and may capture in real-time images of states before and after the negative electrode 20 and the positive electrode 10 are mounted to the lower separator 30a and the upper separator 30b and a moving state thereof while stacked. Also, the computing device compares the acquired images with images stored in advance for good products of the negative electrode 20 and the positive electrode 10, and thus, the size and shape of each of the negative electrode 20 and the positive electrode 10, whether there is a position failure, whether there is damage, or the like may be identified.

Also, the first vision 90a, the second vision 90b, and the third vision 90c are not fixed but coupled to a sliding device (not shown), and/or are configured such that camera angle and zoom may be adjusted. Thus, the negative electrode 20 and the positive electrode 10 may be monitored in real time while moving.

In addition, a separate light source 91 may be added in the vicinity of the lower separator 30a and the upper separator 30b so that the image quality is further improved while the images are captured by the first vision 90a, the second vision 90b, and the third vision 90c.

Also, in the embodiment, each of the first nozzle 70a, the second nozzle 70b, and the third nozzle 70c is provided with a plurality of nipples α, β, and γ having ends through which adhesives A are applied.

The nipples α, β, and γ of each of the first nozzle 70a, the second nozzle 70b, and the third nozzle 70c are spaced apart from each other so that nipples α and γ disposed outside apply the adhesives in the vicinity of an edge of the electrode (the positive electrode and the negative electrode), and a nipple β disposed between the nipples α and γ applies the adhesives to the vicinity of the center of the electrode.

The spray speeds, spray amounts, spray areas, and the like of the adhesives A, which are sprayed from the nipples α, γ, and γ of each of the first nozzle 70a, the second nozzle 70b, and the third nozzle 70c, may be individually controlled.

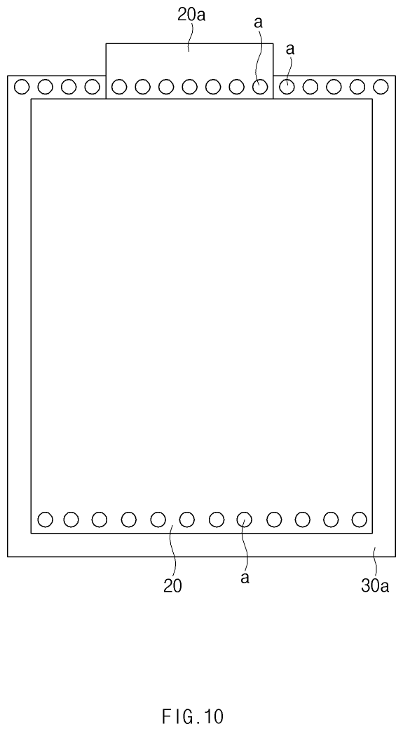

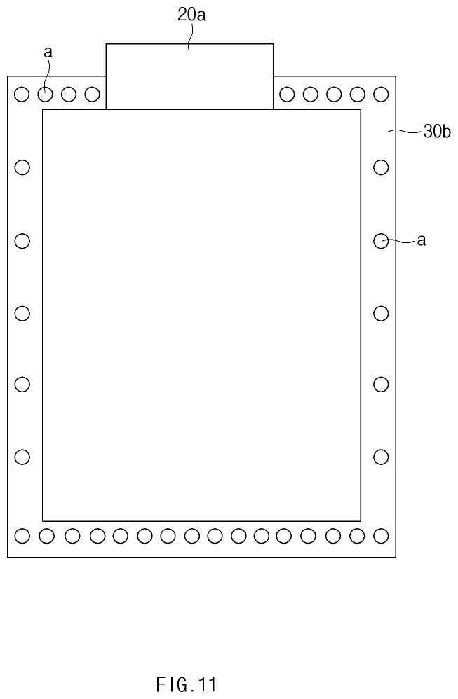

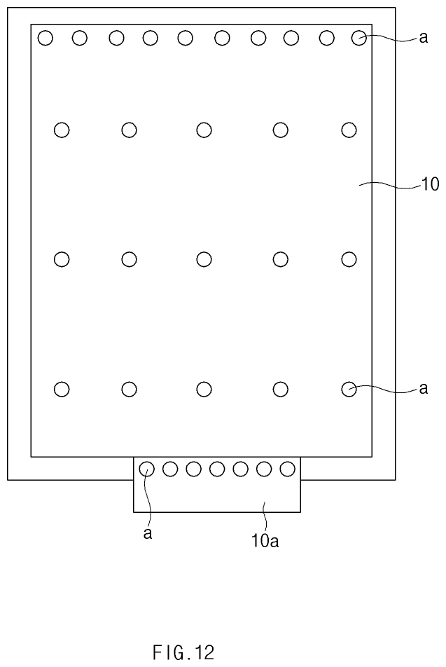

FIG. 10 is a view showing points a to which the adhesive is applied by the first nozzle 70a before the negative electrode 20 is stacked on the lower separator 30a, FIG. 11 is a view (in a state in which the upper separator 30b is stacked on the negative electrode) showing points a to which the adhesive is applied by the first nozzle 70a and the second nozzle 70b after the upper separator 30b is stacked on the negative electrode 20, and FIG. 12 is a view showing points a to which the adhesive is applied by the third nozzle 70c before the positive electrode 10 is stacked on the top surface of the upper separator 30b stacked on the negative electrode 20.

Referring to FIGS. 10 to 12, the adhesive may be sprayed onto the lower separator 30a through the first nozzle 70a in a predetermined size. Here, regions a on which the adhesive is sprayed may be dense in a region in which an negative electrode tab 20a protrudes, with respect to the short sides (an upper end side and a lower end side in FIG. 10) on both sides of the negative electrode 20. That is, the nipple β on the center among the nipples α, β, and γ of the first nozzle 70a does not apply the adhesive, but only the nipples α and γ on both sides apply the adhesive. The spray speed of the nipple a positioned on the negative electrode tab 20a is made greater than that of the nipple γ on the opposite side, and thus, adhesive-applied regions a may be made relatively more dense.

Also, adhesive-applied regions a formed on both the long sides (both sides in FIG. 11) of the negative electrode 20 in FIG. 11 are regions on which the adhesive is sprayed onto the upper separator 30b by the second nozzle 70b, and adhesive-applied regions a, in which the adhesive is sprayed inside the positive electrode 10 in FIG. 12, are regions on which the adhesive is sprayed onto the top surface of the upper separator 30b before the positive electrode 10 is stacked on the upper separator 30b. Here, adhesive-applied regions a may also be made more dense in an area in which a positive electrode tab 10a is positioned.

### Fourth Embodiment

As the fourth embodiment, the present invention provides a unit cell which may be manufactured through the manufacturing method and apparatus described above.

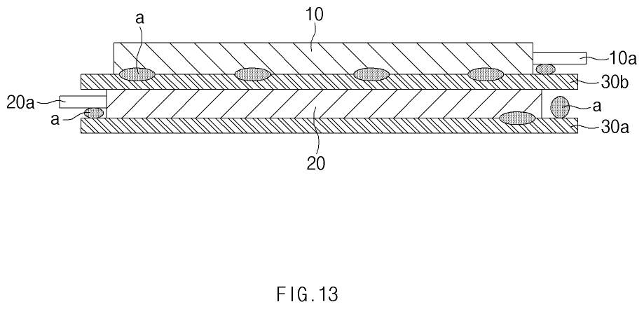

Referring to FIG. 13 showing points in which adhesives are applied in a unit cell 40 according to the present invention, the unit cell provided in the embodiment is a unit cell in which a certain number of separators 30 and electrodes 10 and 20 are alternately stacked. The unit cell is manufactured by stacking a lower separator 30a, one of a negative electrode 20 or a positive electrode 10, an upper separator 30b, and the other of the negative electrode 20 or the positive electrode 10 in this order from the lower side to the upper side. An adhesive is applied to contact surfaces on which the electrode and the separator come into contact with each other, and the electrode and the separator are bonded. That is, FIG. 13 illustrates a structure in which the lower separator 30a, the negative electrode 20, the upper separator 30b, and the positive electrode 10 are stacked in this order from the lower side to the upper side, but a structure in which the lower separator 30a, the positive electrode 10, the upper separator 30b, and the negative electrode 20 are stacked in this order is possible.

Here, the adhesive is applied in such a manner in which a plurality of rows are formed along a specific direction in a plurality of points spaced apart from each other. That is, as shown in FIGS. 10 to 12, the points a on which the adhesive is applied may be formed as at least two rows of adhesive-applied points a through a spray control for the nipples α, β, and γ of each of the first nozzle 70a, the second nozzle 70b, and the third nozzle 70c.

Also, a gap between points in which the adhesive is applied in a specific row may be less than a gap between points a in which the adhesive is applied in another row by controlling spray speeds of the nipples α, β, and γ. For example, the adhesive may be sprayed more densely in contact points of the negative electrode tab 20a and the positive electrode tab 10a which require greater adhesion force.

Also, an area of the points in which the adhesive is applied in the specific row may be greater than an area of the points in which the adhesive is applied in another row. That is, the area of the points a in which the adhesive is applied in the specific row may be made large by controlling spray amounts of the nipples α, β, and γ.

In the method for manufacturing the electrode assembly according to the present invention having the above-described technical features, because the heat and pressure may not be applied or may be applied much weaker than the related art when the electrodes 10 and 20 and the separator 30 are laminated, the distortion between the separator 30 and the electrodes 10 and 20 may be prevented, and the deformation of the electrode 10 and 20 and the separator 30, the damage thereto, and the like may be prevented.

In the present invention, according to the application position of the adhesive A, the separators 30 are bonded to each other, or the separator 30 is bonded to the electrodes 10 and 20, whereby the electrodes 10 and 20 may be fixed. That is, according to the properties of the electrodes 10 and 20 such as size and thickness, the adhesive A is applied to the region to which the electrodes 10 and 20 are mounted, and thus the separator 30 may directly fix and prevent the electrodes from moving, or the separators 30 stacked on both sides of the electrodes 10 and 20 are bonded to each other, and thus the electrodes 10 and 20 may be prevented from moving.

In addition, since the adhesive A may be partially applied to only very small regions such as the corners of the electrodes 10 and 20 in the manufacturing method of the present invention, when this method is additionally applied to the lamination process of the related art in which the heat and pressure are applied, the positions of the electrodes 10 and 20 are temporarily fixed before the lamination process is conducted.

In the present invention, the adhesive A is ejected in the form of small particles and thus may be dispersed and impregnated between coating layers 31 on the surface of the separator.

Also, since the electrodes (the positive electrode, the negative electrode) may be input through the visions 90a, 90b, and 90c and the grippers 100a and 100b, the electrode may be input and mounted to more accurate position compared to the method in which speeds of the cutters 60a and 60b that cut the positive electrode 10 and the negative electrode 20 are controlled.

In addition, since the application amount may be controlled in a specific region of the unit cell according to the present invention, the optimal bonding state may be provided according to the usage of the unit cell and the characteristics of the separator and the electrode.

Those with ordinary skill in the technical field to which the present invention pertains will understand that the present invention may be implemented in other specific forms without changing the technical idea or essential features. Thus, the above-described embodiments are to be considered illustrative and not restrictive to all aspects. The scope of the present invention is defined by the appended claims rather than the detailed description, and various modifications derived from the meaning and scope of the claims and the equivalent concept thereof should be interpreted as being included in the scope of the present invention.

### DESCRIPTION OF THE SYMBOLS

10: Positive electrode

20: Negative electrode

30: Separator (30a: Lower separator, 30b: Upper separator)

40: Unit cell

50a: Nip roller 50b: Auxiliary nip roller

51: Guide roller

60a, 60b, 60c: Cutter

70, 80: nozzle, 70a: First nozzle, 70b: Second nozzle, 70c: Third nozzle

90a: First vision, 90b: Second vision, 90c: Third vision

100a: First gripper, 100b: Second gripper

110a, 110b: Table

1. A method for manufacturing a unit cell in which a certain number of separators and electrodes are alternately stacked, the method comprising:
an adhesive applying operation of continuously providing a lower separator at a relatively lower position and an upper separator at a relatively upper position and applying an adhesive to a surface of at least one separator of the lower separator or the upper separator;
an electrode inputting operation of inputting an electrode onto the lower separator; and
a stacking operation of positioning and stacking the electrode between the lower separator and the upper separator,
wherein the adhesive applied on the at least one -separator allows the electrode to be bonded to the at least one separator or allows the other separator to be bonded to the at least one separator, thereby preventing the electrode from moving relative to at least one of the upper and lower separators.

2. The method of claim 1, wherein, in the adhesive applying operation, the adhesive is applied to a region except for a region in which the electrode is stacked, and the upper and lower separators with the electrode therebetween are bonded to each other.

3. The method of claim 1, wherein, in the adhesive applying operation, the adhesive is applied to a region in which the electrode is stacked, and the electrode and one of the upper separator and the lower separator are bonded to each other over at least a portion of contact surfaces thereof.

4. The method of claim 3, wherein the electrode has a rectangular shape with two short sides being relatively shorter and two long sides being relatively longer, and
in the adhesive applying operation, the adhesive is applied to a region in which the short sides of the electrode is to be positioned.

5. The method of claim 3, wherein the electrode has a rectangular shape with two short sides being relatively short and two long sides being relatively longer, and
in the adhesive applying operation, the adhesive is applied to all regions in which four vertices connecting the short sides and the long sides of the electrode are to be positioned.

6. The method of claim 3, wherein the electrode has a rectangular shape with two short sides being relatively shorter and two long side being relatively longer, and
in the adhesive applying operation, the adhesive is applied to all regions in which the short sides and the long sides of the electrode are to be positioned.

7. The method of claim 6, wherein in the adhesive applying operation, the adhesive is further applied to a region which is parallel to the long sides of the electrode and has both ends respectively connected to the short sides.

8. The method of claim 1, further comprising a roller passing operation of allowing the lower separator, the upper separator, and the electrode, which are stacked on each other, to pass through between nip rollers that face each other, thereby pressing the lower separator, the upper separator, and the electrode.

9. The method of claim 1, wherein, in the adhesive applying operation, the adhesive is applied by being sprayed in the form of small particles together with compressed air.

10. The method of claim 1, wherein, in the adhesive applying operation, the adhesive is applied by being ejected by a change in volume of a pressure chamber that stores the adhesive.

11. The method of claim 1, wherein, after the adhesive applying operation, an individual unit cell, in which a certain number of upper separators, lower separators, and electrodes are alternately stacked, is provided through a cutting process.

12. A method for manufacturing a unit cell, the method comprising: an operation of continuously conveying and supplying, in a longitudinal direction, a lower separator which is located at a relatively lower position;
an operation of applying an adhesive to a portion of a top surface of the lower separator;
an operation of mounting, on the lower separator, a first electrode which is cut into a predetermined size and located on one side of the lower separator;
an operation of continuously conveying and supplying an upper separator which is located at a relatively upper position; and
an operation of applying an adhesive to a portion of one surface of the upper separator,
wherein the upper separator is supplied from an upper side in a direction perpendicular to a traveling direction of the lower separator, and is horizontally conveyed while the adhesive is applied so that the adhesive is applied vertically from the upper side, and
wherein the upper separator is stacked on the first electrode such that the one surface of the upper separator on which the adhesive has been applied is placed on a top surface of the electrode.

13. The method of claim 12, wherein the upper separator is conveyed along a nip roller pressing the lower separator and the first electrode and along a guide roller disposed above the nip roller, and both surfaces of the upper separator are reversed after being conveyed by the nip roller, and
wherein, when the one surface of the upper separator is laid horizontally while conveyed along the guide roller, the adhesive is applied onto the one surface, and the upper separator is input between the nip roller and the first electrode such that the one surface on which the adhesive has been applied covers the top surface of the first electrode.

14. The method of claim 13, further comprising an operation of further applying the adhesive to a portion of a reverse surface of the upper separator after the upper separator is stacked on the electrode.

15. The method of claim 14, further comprising, after the operation of further applying the adhesive to the portion of the reverse surface of the upper separator, an operation of further mounting a second electrode onto the reverse surface of the upper separator on which the adhesive has been applied,
wherein the second electrode mounted on the reverse surface of the upper separator has a different polarity from the first electrode stacked between the upper separator and the lower separator.

16. The method of claim 15, further comprising an operation of allowing the lower separator, the first electrode, the upper separator, and the second electrode, which are stacked in this order from a lower side to the upper side, to pass through between a pair of additional nip rollers, thereby pressing the lower separator, the first electrode, the upper separator, and the second electrode.

17. An apparatus for manufacturing a nit cell, the apparatus comprising:
a lower reel from which a lower separator located at a relatively lower position is unwound;
a first nozzle configured to apply an adhesive to a top surface of the unwound lower separator;
an upper reel from which an upper separator located at a relatively upper position is unwound;
a second nozzle configured to apply the adhesive to one surface of the unwound upper separator;
a guide roller configured to change a conveyance direction of the upper separator so that the upper separator unwound from the upper reel passes horizontally under the second nozzle; and
a nip roller configured to input the upper separator onto a first electrode such that, after passing through the guide roller, the one surface of the upper separator on which the adhesive has been applied faces downward and is bonded to a top surface of the first electrode mounted on the top surface of the lower separator.

18. The apparatus of claim 17, further comprising a first gripper configured to mount the first electrode on the top surface of the lower separator on which the adhesive has been applied.

19. The apparatus of claim 17, further comprising a first vision which is disposed above the first electrode and captures an image of a position, in which the first electrode is mounted by the first gripper, prior to bonding the first electrode to the lower separator.

20. The apparatus of claim 17, wherein the nip roller is disposed on each of both sides of a first stack, which is formed by stacking the lower separator, the first electrode, the upper separator in this order, and presses the first stack while rotating.

21. The apparatus of claim 20, wherein the nip roller and the guide roller are spaced a certain distance from each other, and the upper separator remains horizontal while the upper separator is conveyed between the nip roller and the guide roller.

22. The apparatus of claim 17, wherein the upper separator is stacked such that the surface of the upper separator, on which the adhesive has been applied, is placed as a bottom surface by the nip roller so as to come into contact with the first electrode, and
wherein the apparatus further comprises a third nozzle configured to apply the adhesive to a top surface of the upper separator after the upper separator is stacked on the first electrode.

23. The apparatus of claim 22, further comprising a second gripper configured to mount a second, electrode, which has a different polarity from the first electrode stacked below the upper separator, on the top surface of the upper separator on which the adhesive has been applied.

24. The apparatus of claim 23, further comprising an auxiliary nip roller which is disposed on each of both sides of a second stack, which is formed by mounting the lower separator, the first electrode, the upper separator, and the second electrode in this order from a lower side below, and presses the second stack while rotating.

25. The apparatus of claim 23, further comprising a second vision configured to capture an image of a position, in which the second electrode is to be mounted by the second gripper, prior to mounting the second electrode onto the upper separator.

26. The apparatus of claim 22, wherein each of the first nozzle, the second nozzle, and the third nozzle comprises a plurality of nipples having ends through which the adhesive is applied, and
wherein the nipples of each of the first nozzle, the second nozzle, and the third nozzle are spaced apart from each other so that nipples disposed outside apply the adhesive in a vicinity of an edge of the first electrode, and a nipple disposed between the nipples applies the adhesive to the vicinity of a center of the first electrode.

27. The apparatus of claim 26, wherein spray speeds and spray amounts of the adhesive, which is sprayed from the nipples of each of the first nozzle, the second nozzle, and the third nozzle, are individually controlled.

28. A unit cell for a secondary battery, the unit cell comprising:
a plurality of stacks each having separators and electrodes that are alternately stacked,
wherein the unit cell is manufactured by stacking a lower separator, one of a negative electrode or a positive electrode, an upper separator, and the other of the negative electrode or the positive electrode in this order from a lower side to an upper side of each stack,
wherein an adhesive is applied to contact surfaces on which the negative and positive electrodes and the lower and upper separators come into contact with each other, and the negative and positive electrodes and the lower and upper separators are bonded by the adhesive.

29. The unit cell of claim 28, wherein the adhesive is applied in such a manner in which a plurality of rows of the adhesive are formed along a specific direction in a plurality of points spaced apart from each other.

30. The unit cell of claim 29, wherein a gap between the plurality of points in which the adhesive is applied in a specific row is less than a gap between the plurality of points in which the adhesive is applied in another row.

31. The unit cell of claim 30, wherein an area of the plurality of points in which the adhesive is applied in the specific row is greater than an area of the plurality of points in which the adhesive is applied in the another row.
